(19) United States
(12) Patent Application Publication
(10) Pub. No.: US 2007/0127331 A1
(43) Pub. Date: Jun. 7, 2007

(54) Layer jump control apparatus and method

(75) Inventors: Yao-Yu Lee, Hsin Chu City (TW); Ching-Chuan Chen, Tai Chung City (TW); Jung-Huang Huang, Ma Tou Town (TW)

Correspondence Address: BIRCH STEWART KOLASCH & BIRCH, PO BOX 747, FALLS CHURCH, VA, 22040-0747, US

(73) Assignee: Sunplus Technology Co., Ltd.

(21) Appl. No.: 11/634,305

(22) Filed: Dec. 6, 2006

(30) Foreign Application Priority Data
Dec. 7, 2005 (TW) 094143085

(51) Int. Cl. G11B 7/00

(52) U.S. Cl. 369/44.29; 369/44.35; 369/94

(57) ABSTRACT

A layer jump control apparatus and method is provided to control an optical drive during a layer jump operation. According to the magnitude variations of a focus error signal during a predetermined period, the invention estimates the position and relative velocity of a pickup head and a disk so as to dynamically modify the magnitude of a braking force, causing the optical pickup head to make a stable jump on the target layer, then brake and finally reactivate a closed-loop focus control process without going into an out of lock state.

This application claims the benefit of the filing date of Taiwan Application Ser. No. 094143085, filed on Dec. 7, 2005, the content of which is incorporated herein by reference.

### BACKGROUND OF THE INVENTION

1. Field of the invention

The invention relates to a layer jump control apparatus for controlling a layer jump operation of an optical drive, and particularly to an apparatus and method for controlling a layer jump operation of a digital versatile disk (DVD) drive.

2. Description of the Related Art

Ordinary optical disks can be divided into two categories: single-sided single layer disks (such as CD/VCD disks) and either single-sided dual layer disks or double-sided double layer disks (such as DVD disks). The optical pickup head of an optical drive moves its laser spot between layers while the optical drive is reading a dual layer disk. Thus, the optical drive needs to perform a layer jump operation in order to move the optical pickup head from an initial layer to a target layer. However, since there are layer distance variations existing among either single-layer disks or multilayer disks manufactured by a variety of factories, while performing a layer jump operation, it is required for the optical pickup head to make a stable jump to the target layer and then make a brake, steadily reactivating a closed-loop focus control process without going into an out of lock state.

The U.S. Pat. No. 7,009,917 (hereinafter described as “method A”) discloses a layer jump control method and apparatus for controlling a layer jump operation of an optical drive. An ordinary layer jump operation comprises a kicking process, a holding process, a braking process and a waiting process. FIG. 1 is a block diagram showing a conventional layer jump control apparatus. Referring to FIG. 1, the layer jump control apparatus 100 comprises a driver 150, an optical pickup head 110, a preamplifier 120, a controller 130, a low-pass filter 140 and a switch 160. The optical pickup head 110 has an objective lens (not shown) and a voice coil motor (not shown). The driver 150 is employed to output a driving control signal to drive the voice coil motor to move the objective lens in the vertical directions. The preamplifier 120 generates and delivers a focus error signal to the controller 130 for generating a focus control signal. Meanwhile, the low-pass filter 140 receives the focus control signal and then generates a layer distance balancing signal. If the optical drive is not performing a layer jump operation, the magnitude of the focus control signal determines the magnitude of the driving force. Contrarily, while the optical drive is performing a layer jump operation, the magnitudes of the layer distance balancing signal, a kicking signal and a braking signal determine the magnitude of the driving control signal respectively required for the kicking process, the holding process, the braking process and the waiting process of the layer jump operation. In addition, a layer jump switch signal is applied to the switch 160 for controlling activation of the layer jump operation.

FIG. 2 is a schematic view of each signal during the layer jump operation according to the architecture of FIG. 1.

Referring to FIG. 2, at the beginning of the layer jump operation, the optical drive sends a layer jump switch signal (corresponding to the layer jump switch signal with a positive pulse in FIG. 1, but different from the layer jump control signal of the invention) and then the switch 160 is connected the output terminal of the adder 141 with the driver 150. The low-pass filter 140 generates the layer distance balancing signal. At this moment, the low-pass filter 140 may stop filtering such that the value of the layer distance balancing signal is fixed and does not change over time. Next, the adder 141 adds the layer distance balancing signal and the kicking signal and then sends the sum to the driver 150 for performing the kicking process as shown in FIG. 2. The checking points F1, F2 on the focus error signal is used to determine if the laser spot moves away from the initial layer.

Afterwards, once it is assured that the laser spot moves away from layer 0, the kicking signal is eliminated so that only the layer distance balancing signal is provided to the driver 150 for performing the holding process; therefore, the objective lens (not shown) keeps moving towards the target layer (layer 1), i.e., the laser spot moving towards the target layer. A brake start point F3 on the focus error signal is used to determine whether or not the holding process is completed. Then, while the focus error signal reaches the brake start point point F3, it indicates that the objective lens is moving close to the linear control area of layer 1. At this moment, both the braking signal and the layer distance balancing signal are applied to the driver 150 for performing the holding process for a predetermined period T. Next, only the layer distance balancing signal is provided to the driver 150 for performing the waiting process. A closed-loop focus control point F4 on the focus error signal is used to determine whether or not the waiting process is completed. After the waiting process is completed, the switch 160 is switched to receive the focus control signal. At this time, the low-pass filter 140 continues to update the layer distance balancing signal and the layer jump operation is completed.

In the previously discussed method A, the layer distance balancing signal is used to perform the holding process, the braking process and the waiting process as well as the layer jump operation, finally completing the layer jump operation.

The U.S. Pat. No. 6,801,485 (hereinafter described as “method B”) discloses a method of layer jump braking control. Based on the architecture of FIG. 1, the kicking process and holding process of the layer jump operation performed are the same for both method A and method B, but the timings for performing the braking process and the waiting process are different. The timings for performing the braking process and the waiting process in method B are described as follows. While the focus error signal reaches the brake start point F3, the braking process is performed according to the focus error signal and the layer distance balancing signal. Once the focus error signal reaches the closed-loop focus control point F4, a closed-loop focus control process is reactivated. Moreover, on condition that the focus error signal has not reached the closed-loop focus control point F4 after the braking process is performed for a predetermined period T, the waiting process is activated according to the layer distance balancing signal.

FIG. 3A is a schematic view of signals in a braking process performed according to method B. FIG. 3B is a schematic view of signals in another braking process performed according to method B. FIG. 3C is a schematic view of signals in still another braking process performed according to method B.

With respect to the operations of the braking process, three possible cases might occur and are respectively described in reference to FIGS. 3A-3C. Referring now to FIG. 3A, in a first case that the optical pickup head has a slow layer jump velocity and the focus error signal has not reached a maximum value Fmax yet after the braking process is performed for a predetermined period T1. Therefore, the braking signal is eliminated so that only the layer distance balancing signal is sent for determination of the driving force, performing the waiting process until the focus error signal reaches the maximum value Fmax. When the focus error signal reaches the maximum value Fmax, the closed-loop focus control point F4 is determined by three quarters of the maximum value Fmax of the focus error signal and then the waiting process continues until the focus error signal reaches the closed-loop focus control point F4. Accordingly, the closed-loop focus control process is reactivated and the layer jump operation is completed.

Referring to FIG. 3B, in a second case, the optical pickup head has a moderate layer jump velocity and the focus error signal reaches the maximum value Fmax during the braking process. Even though the braking period T2 is not over yet, the closed-loop focus control point F4 can be determined by three quarters of the maximum value Fmax of the focus error signal and the braking process continues until the braking period T2 is over. During the braking period T2, the optical drive continuously detects if the focus error signal reaches the closed-loop focus control point F4. However, if the focus error signal does not reach the closed-loop focus control point F4 at the end of the braking period T2 as shown in FIG. 3B, the braking signal is eliminated so that only the layer distance balancing signal is sent for determination of the driving force, thus performing the waiting process until the focus error signal reaches the closed-loop focus control point F4. Accordingly, the closed-loop focus control process is reactivated and the layer jump operation is completed.

Referring to FIG. 3C, in a third case, the optical pickup head has a fast layer jump velocity. Similar to the second case of FIG. 3B, the focus error signal reaches not only the maximum value Fmax during the braking process, but also the closed-loop focus control point F4 by the end of the braking period T3. At this moment, regardless of the braking period T3, the braking signal is eliminated and the braking process is skipped in order to perform the layer jump operation smoothly. Thus, the closed-loop focus control process is reactivated in advance and the layer jump operation is completed.

In summary, method B and method A are quite similar, but different in timings for performing the braking process. In method B, the braking process is performed for a predetermined period according to the braking signal and the layer distance balancing signal after the focusing error reaches the checking point F3. Afterwards, while the focus error signal reaches the closed-loop focus control point F4, the braking signal is directly eliminated and thus the closed-loop focus control process is reactivated.

The above-mentioned two methods merely deal with the layer distance balancing signal (method A) and timings for braking and reactivating the closed-loop focus control process (method B), but do not account for the relative velocity between the disk and the optical pickup head. If the relative velocity is too fast or too slow, the layer jump failure might occur in the above-mentioned two methods.

### SUMMARY OF THE INVENTION

In view of the above-mentioned problems, an object of the invention is to provide a layer jump control apparatus for estimating the positions and the relative velocity of an optical pickup head and a disk to dynamically modify the magnitude of a braking force, accordingly making a steady layer jump.

To achieve the above-mentioned object, the layer jump control apparatus is employed to control a layer jump operation of an optical drive. Wherein, the layer jump operation comprises a kicking process, a sliding process and a braking process. The layer jump control apparatus comprises an optical pickup head, a preamplifier, a controller, a brake velocity compensation controller, two switches and a driver.

The optical pickup head having an objective lens and a voice coil motor drives the voice coil motor to move the objective lens vertically according to a driving control signal, thereby controlling the focus position of the laser spot. The preamplifier generates a focus error signal. The controller receives the focus error signal and generates a focus control signal. The brake velocity compensation controller estimates positions of both the optical pickup head and a disk and the relative velocity between the optical pickup head and the disk in order to determine a brake control signal according to the magnitude variations of the focus error signal. The first switch receives and outputs a layer jump control signal while either the kicking process or the sliding process is being performed, but receives and outputs the brake signal while the braking process is being performed. The second switch receives and outputs the focus control signal before the layer jump operation is performed, but receives and outputs the output signal of the first switch while the layer jump operation is being performed. The driver receives the output signal of the second switch to determine the driving control signal.

Another object of the invention is to provide a layer jump control method for an optical drive, wherein the optical drive at least comprises a optical pickup head, the method comprising the steps of: generating a layer jump control signal to perform a kicking process according to a focus error signal; gradually decreasing the layer jump control signal to perform a sliding process; estimating positions of both the optical pickup head and a disk and the relative velocity between the optical pickup head and the disk for determination of a brake control signal to perform a braking process according to the magnitude variations of the focus error signal, wherein a braking force with different braking forces varies with both positions and the relative velocities of the disk; and, reactivating a closed-loop focus control process while the focus error signal reaches a closed-loop focus control point.

According to a feature of speed feedback, during a multi-stage braking process, the magnitude variations of the focus error signal during a predetermined period, i.e., the positions of both the optical pickup head and a disk respectively and the relative velocity between the optical pickup head and the disk, determine the magnitude of the brake control signal (or braking force) at each stage. Further, the brake control signal (or braking force) at each stage may even be inverted, causing the optical pickup head to slow down steadily and operate within the frequency range of the focus control loop. Another feature of the invention is that the layer jump control signal is decreased gradually after the focus error signal reaches the checking point F2, preventing the optical pickup head from moving too fast and ensuring that the optical pickup head moves away the initial layer steadily.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing a conventional layer jump control apparatus.

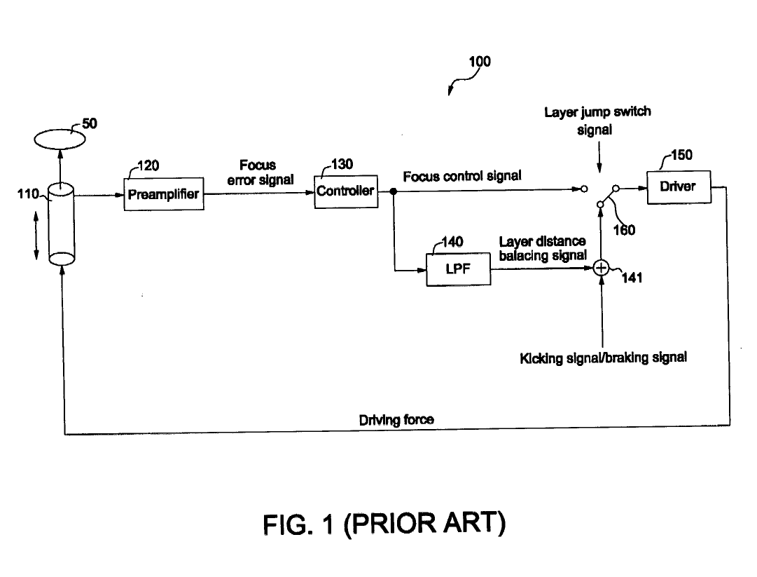

FIG. 2 is a schematic view of each signal during the layer jump operation according to the architecture of FIG. 1.

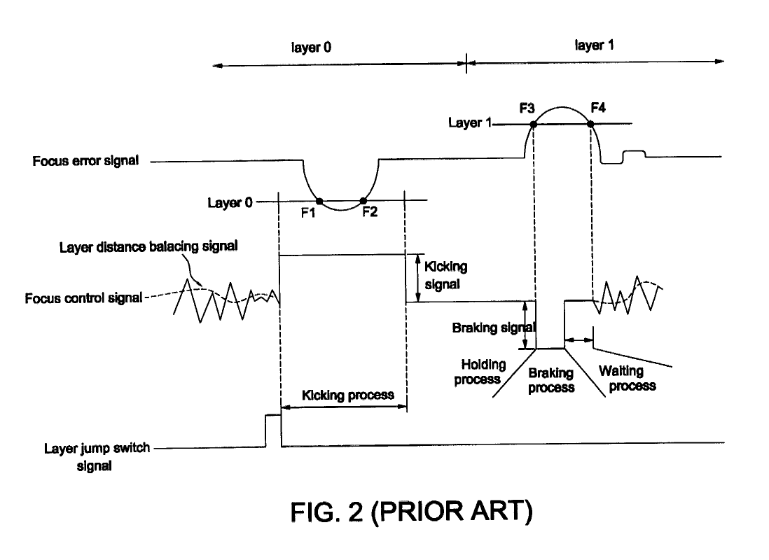

FIG. 3A is a schematic view of signals in a braking process performed according to method B.

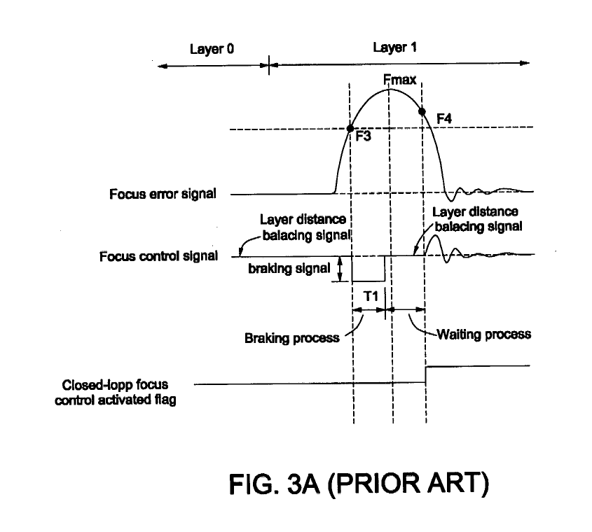

FIG. 3B is a schematic view of signals in another braking process performed according to method B.

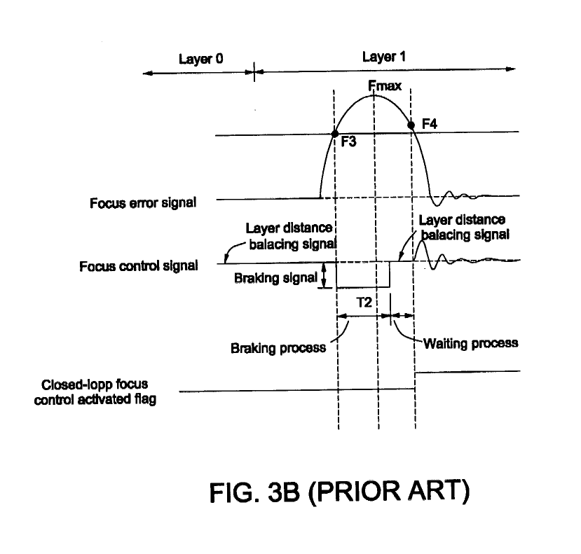

FIG. 3C is a schematic view of signals in still another braking process performed according to method B.

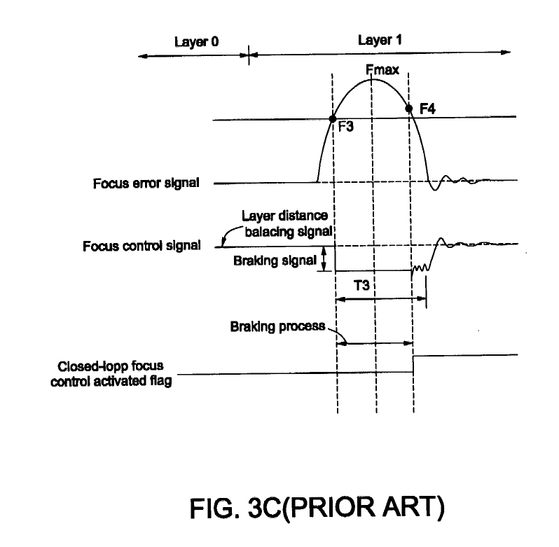

FIG. 4 is a block diagram of a layer jump control apparatus according to the invention.

FIG. 5 is a block diagram of a layer jump control apparatus according to a first embodiment of the invention.

FIG. 6 is a block diagram of a layer jump control apparatus according to a second embodiment of the invention. During the layer jump operation,

FIG. 7 is a flow chart illustrating a layer jump control method for an optical drive according to the invention.

FIG. 8A is a schematic view showing the focus error signal and the focus control signal in the braking process performed in a first embodiment of the invention.

FIG. 8B is a schematic view of signals during the layer jump operation according to a second embodiment of the invention.

FIG. 8C is a schematic view of signals during the layer jump operation according to a third embodiment of the invention.

FIG. 8D is a schematic view of signals during the layer jump operation according to a fourth embodiment of the invention.

### DETAILED DESCRIPTION OF THE INVENTION

The layer jump control apparatus and method of the invention will be described with reference to the accompanying drawings.

The invention regards the focus error signal as a function of distance and uses a brake velocity compensation controller for calculating the positions of the optical pickup head and a disk respectively and the relative velocity between the optical pickup head and the disk based on the magnitude variations of the focus error signal during a predetermined period, thereby dynamically modifying the magnitude and polarities of the brake control signal. Accordingly, during the layer jump, both a layer jump control signal and a brake control signal each with a appropriate magnitude cause the optical pickup head to make a stable jump on the target layer and then make a brake, steadily reactivating a closed-loop focus control process without going into an out of lock state.

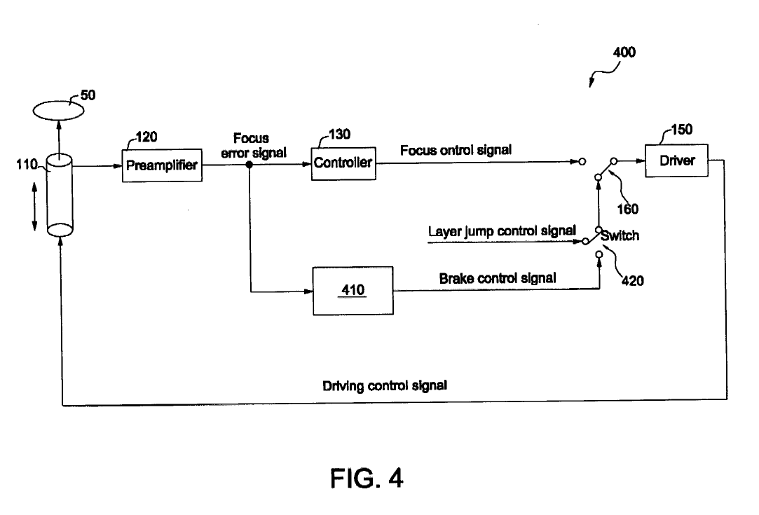

FIG. 4 is a block diagram of a layer jump control apparatus according to the invention.

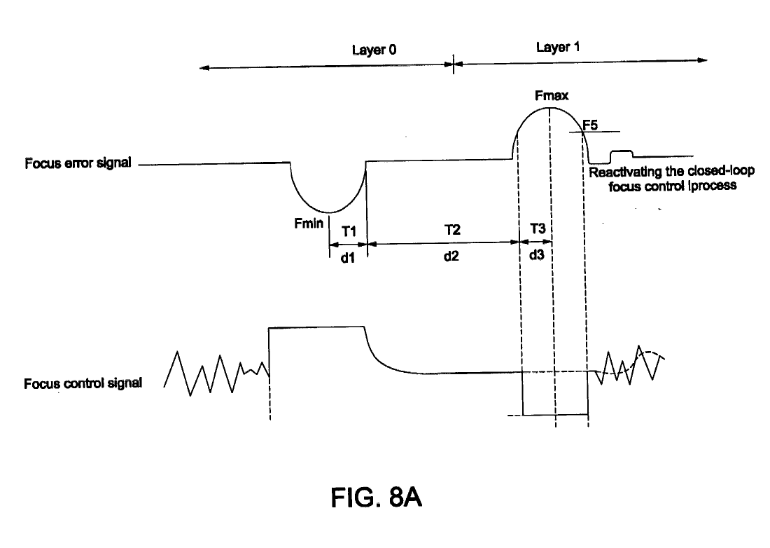

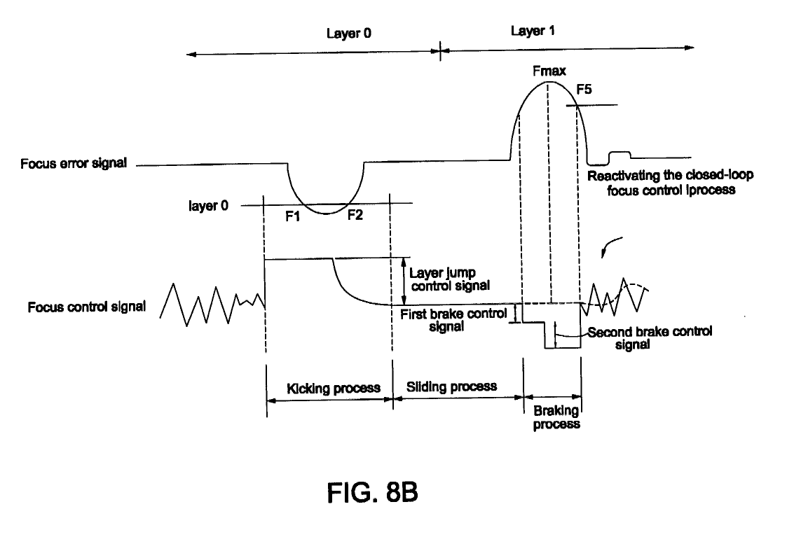

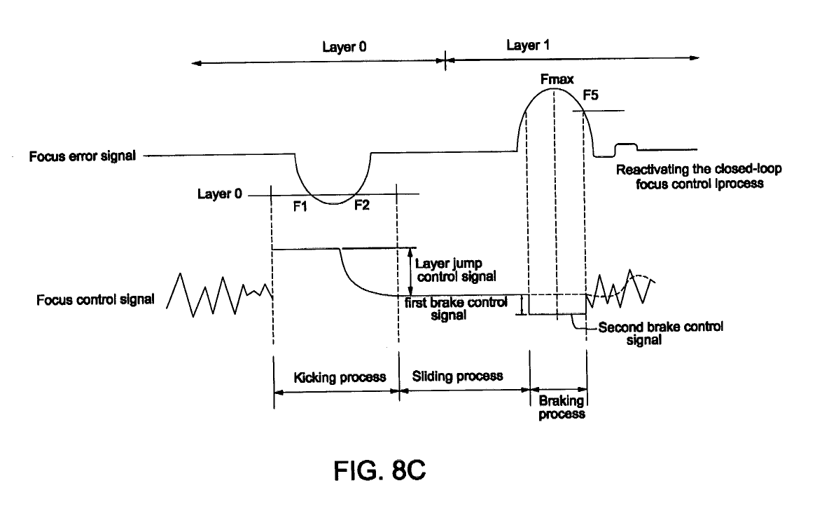

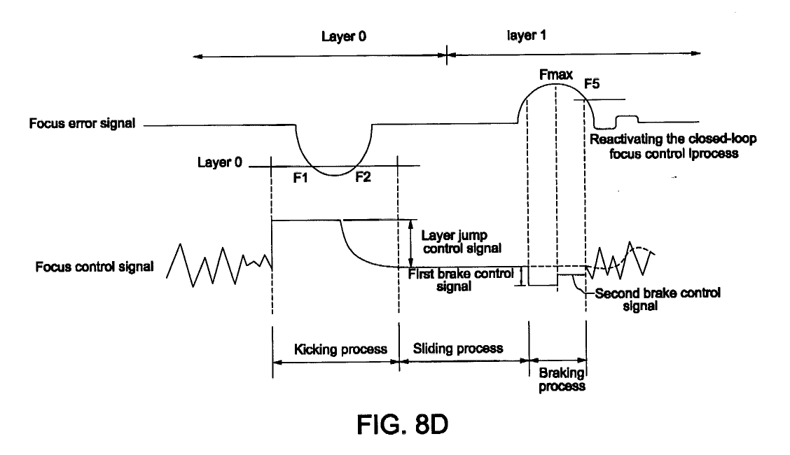

Referring to FIG. 4, a layer jump control apparatus 400, according to the invention, comprises an optical pickup head 110, a preamplifier 120, a controller 130, a brake velocity compensation controller 410, two switches 160, 420 and a driver 150. Since the operations of the optical pickup head 110, the preamplifier 120, the controller 130 and a driver 150 are well-known, the description thereof will be omitted. According to the magnitude variations of the focus error signal, the brake velocity compensation controller 410 estimates the positions of the optical pickup head and a disk respectively and the relative velocity between the optical pickup head and a disk to determine an appropriate brake control signal (referring to the description of FIGS. 8A-8D). The switch 420 selectively receives either a brake control signal or a layer jump control signal. That is, the switch 420 receives and outputs the layer jump control signal while performing the kicking process or the sliding process. Instead, the switch 420 receives and outputs the brake control signal while performing the braking process. Likewise, the switch 160 selectively receives either a focus control signal or the output signal of the switch 420. That is, the switch 160 receives and outputs the focus control signal if the layer jump operation is not performed. Instead, the switch 420 receives and outputs the output signal of the switch 420 while performing the layer jump operation.

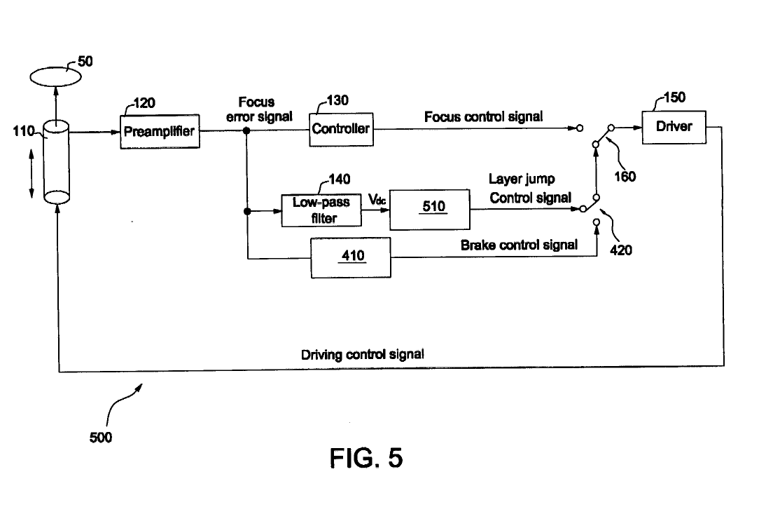

FIG. 5 is a block diagram of a layer jump control apparatus according to a first embodiment of the invention. Referring to FIG. 5, a layer jump control apparatus 500, according to the invention, comprises an optical pickup head 110, a preamplifier 120, a controller 130, a brake velocity compensation controller 410, two switches 160, 420, a low-pass filter 140, a layer jump compensation controller 510 and a driver 150. The low-pass filter 140 receives the focus error signal, performs filtering and then generates a layer distance balancing signal. The main function of the low-pass filter 140 is to measure the direct current (DC) voltage level of the focus error signal so as to estimate the position of the optical pickup head. In accordance with the layer distance balancing signal The layer jump compensation controller 510 calculates the layer jump control signal with the most appropriate magnitude to perform the kicking process. With respect to the position (or state) of the optical pickup head 110, the layer jump compensation controller 510 estimates the magnitude of the force to be applied and then generates the corresponding layer jump control signal to perform the kicking process. The DC voltage level V_{dc} generated by the low-pass filter 140 is divided into several categories, such as . . . 1.2<V_{dc}<=1.5V; 1.5<V_{dc}<=1.8; 1.8<V_{dc}<=2.0 . . . etc. According to the category that the DC voltage level V_{dc} falls into, an layer jump control signal with an appropriate magnitude will be given. Since the other circuits of the first embodiment are the same as those of the apparatus 400, the description is omitted herein.

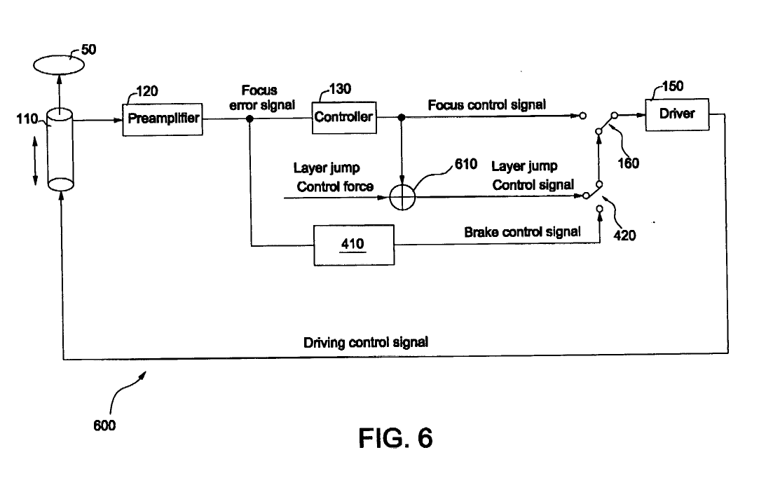

FIG. 6 is a block diagram of a layer jump control apparatus according to a second embodiment of the invention. During the layer jump operation, the layer jump control signal is generated by adding a given layer jump control force and the focus control signal. Referring to FIG. 6, in the second embodiment, the adder 610 adds the layer jump control force and the focus control signal to generate the layer jump control signal. Since the other circuits of the second embodiment are the same as those of the apparatus 400, the description is omitted herein.

According to the invention, the layer jump control signal is generated by either combining the low-pass filter 140 and the layer jump compensation controller 510 (as shown in FIG. 5), or adding the layer jump control force and the focus control signal (as shown in FIG. 6). The above-mentioned layer jump control apparatuses 400, 500, 600 are all applicable to single-sided dual layer DVD disks or double-sided dual layer DVD disks, or any type of storage media required to perform layer jump operations.

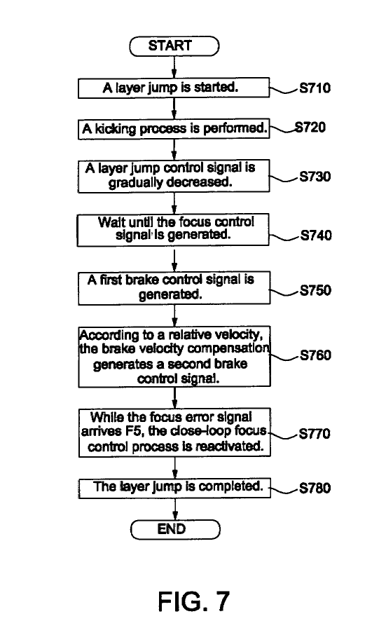

FIG. 7 is a flow chart illustrating a layer jump control method for an optical drive according to the invention. There are three processes required for a layer jump operation performed by the layer jump control apparatus, i.e., a kicking process, a sliding process and a braking process. The layer jump control method of the invention will now be described with reference to FIG. 5 and FIG. 7.

Before the layer jump operation is performed, the driver 150 is connected to the output terminal of the controller 130. The focus control signal generated by the controller 130 controls the driving control signal via the driver 150 to keep the laser spot of the optical pickup head on the initial layer. In the meantime, the low-pass filter 140 receives and filters the focus error signal to generate a continuously changing layer distance balancing signal. According to the continuously changing layer distance balancing signal, the layer jump compensation controller 510 estimates the position (or state) of the optical pickup head 110, calculates the magnitude of the force to be applied and then generates a corresponding layer jump control signal to perform the kicking process.

Step S710: At the start of the layer jump operation, the switch 160 starts to receive the layer jump switch signal; meanwhile, the low-pass filter 140 and the layer jump compensation controller 510 stop calculation, therefore keeping the layer distance balancing signal and the layer jump control signal constant.

Step S720: The driver 150 receives the layer jump control signal to perform the kicking process.

Step S730: As the focus error signal passes through the checking point F2, the layer jump control signal is gradually decreased to prevent the optical pickup head 110 from moving too fast and to ensure that the optical pickup head 110 moves steady away from the initial layer and then slides for a period of time.

Step S740: If the focus error signal on the target layer is detected, the sliding process is terminated.

Step S750: The brake velocity compensation controller 410 generates a first brake control signal to perform a braking process.

Step S760: Based on the magnitude variations of the focus error signal during a predetermined period, the brake velocity compensation controller 410 estimates the positions of the optical pickup head 110 and the disk 50 respectively and the relative velocity between the optical pickup head 110 and the disk 50, and then generates a second brake control signal to perform the braking process, thereby slowing down the optical pickup head 110 and operating within the frequency range of the focus control loop.

Step S770: As the focus error signal reaches a closed-loop focus control point F5, the closed-loop focus control process is reactivated.

Step S780: The layer jump operation is over. The low-pass filter 140 and the layer jump compensation controller 510 restart to perform calculation, finally completing the layer jump operation from layer 0 to layer 1.

FIG. 8A is a schematic view showing the focus error signal and the focus control signal in the braking process performed in a first embodiment of the invention.

According to the invention, in the step S760, the relative velocity between the optical pickup head 110 and the disk 50 determines the magnitude of the braking force (or the braking control signal), wherein the optical pickup head 110 is moving from the initial layer to the target layer. Further, based on the feature of speed feedback, the braking process may even include multi-stage braking force, causing the optical pickup head to slow down steadily and operate within the frequency range of the focus control loop. Calculation of the moving velocity of the optical pickup head 110 is hereinafter described with reference to FIG. 8A. According to the magnitude of the focus error signal, a minimum value Fmin and a maximum value Fmax of the focus error signal can be measured.

Suppose that T1, T2 and T3 denote the time periods which the optical pickup head 110 spends moving across layer 0, from layer 0 to layer 1, and across layer 1, respectively. That is, T1 denotes the time period which the optical pickup head 110 moves from the minimum value Fmin to the zero value of the focus error signal; T2 denotes the time period which the focus error signal keeps zero. Likewise, T3 denotes the time period which the optical pickup head 110 moves from the zero value to the maximum value Fmax of the focus error signal. Further, d1, d2 and d3 denote the distances that the optical pickup head 110 moves for the time periods T1, T2 and T3, respectively. The distances d1 and d3 can be looked up in the specification of the optical pickup head 110 while the distance d2 can be obtained by means of uniform upward movement of the optical pickup head 110 during the layer jump operation.

If T1, T2, T3, d1, d2 and d3 are given, an average velocity can be derived as follows: Vave_i=di/Ti, where i=1, 2, 3.

According to the invention, Vave_1 or Vave_2 determines the magnitude of the first brake control signal (or the first brake force), whereas Vave_3 determines the magnitude of the second brake control signal (or the second brake force). Accordingly, with respect to different relative velocities between the optical pickup head and the disk, the invention dynamically modifies the magnitude and polarities of the brake control signal, thus increasing the stability of the braking process.

FIG. 8B is a schematic view of signals during the layer jump operation according to a second embodiment of the invention. FIG. 8C is a schematic view of signals during the layer jump operation according to a third embodiment of the invention. FIG. 8D is a schematic view of signals during the layer jump operation according to a fourth embodiment of the invention.

With respect to the braking process discussed in the steps S740-S760, three cases may occur and will be described with reference to FIGS. 8B-8D as follows.

Referring to FIG. 8B, in the second embodiment, the optical pickup head 110 has a relatively fast layer jump velocity and the slope of the focus error signal on layer 1 is quite steep. Once the focus error signal on layer 1 is generated (i.e., the focus error signal being not equal to zero), the brake velocity compensation controller 410 generates the first brake control signal according to the average velocity Vave_1 or Vave_2. After the focus error signal reaches the maximum value Fmax, the average velocity Vave_3 of the optical pickup head 110 is still high. Accordingly, with respect to the average velocity Vave_3, the brake velocity compensation controller 410 generates the second brake control signal whose magnitude is larger than that of the first brake control signal, causing the optical pickup head 110 to slow down fully until the focus error signal reaches the closed-loop focus control point F5. Finally, the closed-loop focus control process is reactivated and the layer jump operation is completed.

Referring to FIG. 8C, in the third embodiment, the optical pickup head 110 has a moderate layer jump velocity and the slope of the focus error signal on layer 1 is also moderate. Once the focus error signal on layer 1 is generated, the brake velocity compensation controller 410 generates the first brake control signal according to the average velocity Vave_1 or Vave_2. After the focus error signal reaches the maximum value Fmax, the average velocity Vave_3 of the optical pickup head 110 is a reasonable expectation. Accordingly, with respect to the average velocity Vave_3, the brake velocity compensation controller 410 generates the second brake control signal whose magnitude is equal to that of the first brake control signal, causing the optical pickup head 110 to slow down gently until the focus error signal reaches the closed-loop focus control point F5. Finally, the closed-loop focus control process is reactivated and the layer jump operation is completed.

Referring to FIG. 8D, in the fourth embodiment, the optical pickup head 110 has a relatively slow layer jump velocity and the slope of the focus error signal on layer 1 is also gentle. Once the focus error signal on layer 1 is generated, the brake velocity compensation controller 410 generates the first brake control signal according to the average velocity Vave_1 or Vave_2. After the focus error signal reaches the maximum value Fmax, the average velocity Vave_3 of the optical pickup head 110 is too slow to reach layer 1. Accordingly, with respect to the average velocity Vave_3, the brake velocity compensation controller 410 generates the second brake control signal whose magnitude is less than that of the first brake control signal, causing the optical pickup head 110 not to brake too fast. In contrast, the brake velocity compensation controller 410 may even generate the second brake control signal opposite to the first brake control signal, allowing the optical pickup head 110 to accelerate some more until the focus error signal reaches the closed-loop focus control point F5 smoothly. Finally, the closed-loop focus control process is reactivated and the layer jump operation is completed.

It should be noted that the layer jump operation is previously discussed in the first to the fourth embodiments in which the optical pickup head moves from layer 0 to layer 1. Except that layer jump control signal and the brake control signal have to be inverted, the method of the invention is equally applicable in the layer jump operation from layer 1 to layer 0.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A layer jump control apparatus, for controlling a layer jump operation of an optical pickup head in an optical drive from an initial layer to a target layer, the optical pickup head having a voice coil motor and an objective lens moved vertically by the voice coil motor according to a driving control signal, and the layer jump operation comprising a kicking process, a sliding process and a braking process, the layer jump control apparatus comprising:
a preamplifier, for generating a focus error signal;
a controller, for receiving the focus error signal and generating a focus control signal;
a brake velocity compensation controller, for estimating position of the optical pickup head and relative velocity between the optical pickup head and the disk according to the magnitude variations of the focus error signal, and for generating a brake control signal according to the position and the relative velocity;
a first switch, for receiving a layer jump control signal and the brake signal and outputting the layer jump control signal during the kicking process or the sliding process and outputting the brake signal during the braking process as a first control signal;
a second switch, for receiving the focus control signal and the first control signal and outputting the focus control signal before the layer jump operation is performed and outputting the first control signal during the layer jump operation as a second control signal; and
a driver, for receiving the second control signal and generating the driving control signal.

2. The apparatus of claim 1, wherein the brake velocity compensation controller generates a first brake force of the brake control signal during the braking process in accordance with the moving velocity either on the initial layer or between the initial layer and the target layer while the focus error signal on the target layer is being generated, and wherein the brake velocity compensation controller generates a second brake force of the brake control signal in accordance with the moving velocity on the target layer while the focus error signal passes through a maximum value.

3. The apparatus of claim 1, further comprising:
a low-pass filter, for receiving the focus error signal and generating a layer distance balancing signal; and
a layer jump compensation controller, for receiving the layer distance balancing signal, and generating the layer jump control signal.

4. The apparatus of claim 3, wherein the layer distance balancing signal is the direct current voltage level of focus error signal.

5. The apparatus of claim 1, further comprising:
an adder, for adding a layer jump control force signal and the focus control signal to generate the layer jump control signal.

6. The apparatus of claim 1, wherein the amplitude the layer jump control signal is gradually decreased to perform the sliding process after the kicking process is completed.

7. The apparatus of claim 1, wherein the optical drive is a DVD drive.

8. The apparatus of claim 1, wherein the brake control signal is used to determine a braking force.

9. A layer jump control method for an optical drive, wherein the optical drive comprises a optical pickup head, the method comprising the steps of:
generating a layer jump control signal to perform a kicking process according to a focus error signal;
decreasing the magnitude of the layer jump control signal to perform a sliding process;
estimating the position of the optical pickup head and relative velocity between the optical pickup head and the disk according to the magnitude variations of the focus error signal and determining a brake control signal according to the position and the relative velocity to perform a braking process; and
reactivating a closed-loop focus control process while the focus error signal reaches a closed-loop focus control point.

10. The method of claim 9, wherein the step of estimating further comprises:
generating a first brake force of the brake control signal to perform the braking process in accordance with moving velocity either on the initial layer or between the initial layer and the target layer while the focus error signal on the target layer is being generated; and
generating a second brake force of the brake control signal to perform the subsequent braking process in accordance with the moving velocity on the target layer while the focus error signal on the target layer passes through a maximum value.

11. The method of claim 9, wherein the step of gradually decreasing the layer jump control signal comprises:
generating a focus control signal according to the focus error signal; and
adding the focus control signal and a layer jump control force signal to generate the layer jump control signal.

12. The method of claim 9, wherein the step of gradually decreasing the layer jump control signal comprises:
performing low-pass filtering to generate a layer distance balancing signal according to the focus error signal; and
calculating the layer jump control signal according to the layer distance balancing signal.

13. The method of claim 12, wherein the layer distance balancing signal is the direct current voltage level of focus error signal.

14. The method of claim 9, wherein the optical drive is a DVD drive.

15. The method of claim 9, wherein the brake control signal is used to determine a braking force.
